(19) United States
(12) Patent Application Publication
(10) Pub. No.: US 2003/0001294 A1
(43) Pub. Date: Jan. 2, 2003

(54) Water distribution structure for evaporative cooling system

(76) Inventor: Dennis L. Permenter, Joaquin, TX (US)

Correspondence Address: CONLEY ROSE & TAYON, P.C., P. O. BOX 3267, HOUSTON, TX, 77253-3267, US

(21) Appl. No.: 09/897,368

(22) Filed: Jul. 2, 2001

(51) Int. Cl. B01F 3/04

(52) U.S. Cl. 261/97; 261/106; 261/DIG. 3; 261/DIG. 43

(57) ABSTRACT

The invention comprises a water distribution mechanism for an evaporative air conditioner that alleviates splashing of water out of that mechanism. Further, the invention alleviates the problem of water running horizontally along a distribution edge of a water distribution mechanism to drip off at the lowest point. To compensate for the splashing problem, the invention comprises a structure that requires the water exiting the water distribution mechanism strike at least one surface of the water distribution mechanism on its way down. To compensate for the problem of water running horizontally because of sags and the like, the invention comprises a plurality of teeth along the bottom edge of the water distribution bonnet that therefore forces the water to drip rather than to move horizontally. Another aspect of the invention comprises a plurality of modular troughs and housings that may be advantageously connected or bolted together to create an evaporative air conditioning system of an appropriate size given the size of the poultry house to be cooled.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates generally to evaporative cooling systems. More particularly, the preferred embodiment of the present invention relates to a water distribution system for evaporative coolers for poultry houses. Owners and operators of poultry houses have ordinary skill in this art.

2. Background of the Invention

In the operation of poultry houses, whether for housing broiler chickens or for producing eggs, it is important to keep animals cool, even in the hottest months of the summer. Because the square footage of poultry houses may exceed several thousand square feet, the cost and expense of operating refrigerated air conditioning to keep the poultry houses at the proper temperature is prohibitively expensive, not only from a capital outlay standpoint, but also from standpoint of paying monthly energy bills. With those factors in mind, most owners/operators of poultry houses cool those houses by means of evaporative air conditioning.

FIG. 1 shows a simplified perspective view of an evaporative cooling system for a poultry house. In particular, FIG. 1 shows four fans 2A-D. These fans 2A-D are designed to pull air through the poultry house 4. During some times of the year, this air flow alone may be sufficient to keep the animals within the house at the desired temperature. However, in the hotter part of the year, the air flow alone may be insufficient.

Referring still to FIG. 1, there is shown an evaporative air conditioning panel 6 on a side of the poultry house 4. Although the drawing of FIG. 1 shows the evaporative air conditioning system panel 6 on a side of the poultry house 4, this likewise may be placed at any location generally opposite of the fans 2A-D. Further, multiple panels 6 may be used, e.g. one on each side of the poultry house. Generally speaking, the evaporative air conditioning panel 6 comprises a water distribution mechanism, and a corrugated paper pad soaked with water. As air moves through the corrugated paper pad, drawn by the cooling fans 2A-D, the air is cooled by heat loss to the evaporation of the water in the corrugated pads. In this way, a temperature drop is seen across the corrugated paper pad, as well as a corresponding humidity increase.

More particularly, and referring to FIG. 2, the evaporative air conditioning unit 6 may comprise the corrugated paper pad 8. As shown in FIG. 2, water is typically allowed to flow through the pad in the direction of gravity, while air flow is typically at right angles to that water flow. Water is typically applied to the corrugated paper pad 8 by means of a water distribution mechanism 10. Water that is not evaporated off or otherwise soaked up by the corrugated pad 8 is collected in a basin 12 which flows to a sump (not shown). From the sump, a pump moves the water back to the inlet 14 of the water distribution mechanism 10, and the process continues. Any water lost in the system to evaporation or spillage (which is discussed more fully below) is replaced at the sump.

In this day of water conservation and environmental concern, it is becoming increasingly important to minimize water waste. Moreover, some environmental agencies, e.g., the Environmental Protection Agency, may already, or will in the future, tightly regulated water usage and water waste. In that respect, the evaporative air conditioning systems for poultry houses of the prior art are deficient in their design and construction for their waste of water and inefficiencies in water consumption.

Referring now to FIG. 3, there is shown a cross-sectional view of a prior art evaporative air conditioning system taken substantially along line 3-3 of FIG. 2. Although the prior art may be deficient in many respects, of particular concern in this application is the water distribution mechanism 10. In particular, the prior art water distribution mechanism comprises at least a bonnet 16 and a spray pipe 18. The spray pipe 18 has on its inside water at a pressure higher than atmospheric. The spray pipe 18 further has a plurality of small holes 20 drilled in the top which allows that water to escape in an upward direction. As indicated by the dashed lines in FIG. 3, the water typically strikes the bonnet 16 and then splatters and falls down toward the corrugated paper pad 8. However, the bonnet 16 of the prior art devices is deficient in at least two ways.

The first way the prior art bonnet is deficient is that it does not adequately stop or slow water splattering from the top of the bonnet toward the corrugated paper pad 8. Prior art bonnets 16 are typically made by splitting a section of pipe in half, thus making both halves available for bonnet service. Referring still to FIG. 3, there is shown a pie-shaped region alpha through which water that strikes the bonnet directly above the spray pipe 18 may move without impediment toward the corrugated pad 8. Support 17, while shown in the particular cross-section, is a periodically spaced support for the spray pipe 18, and thus presents no impediment to water movement, except for the few locations where the support 17 is located. Depending upon the height of the spray pipe 18 and bonnet 16 above the corrugated pad 8, it is possible that water may splatter off the bonnet 16 and effectively spray beyond the outer edge 22 of the corrugated paper pad 8. Water that does not reach the corrugated paper pad 8 in these prior art systems thus falls to the ground, either inside or outside the unit 6, and is wasted.

The second prior art deficiency in the use of water is improper distribution of water across the corrugated paper pad 8. In particular, for most efficient operation of the evaporative air conditioning system 6, it is important that water flow down the corrugated paper pad 8 be evenly distributed. Referring now to FIG. 4, there is shown a side-view of the bonnet 16 taken substantially along line 4-4 of FIG. 3. FIG. 4 thus shows, in an exaggerated manner, that the bonnet 16 and the spray pipe 18 (not shown in FIG. 4) may sag for various reasons, including inadequate support. It has been discovered that in situations where the bonnet 16 sags, water does not drip from the bonnet evenly. Rather, and still referring to FIG. 4, the water that reaches the lower edge of the bonnet at a higher elevation, e.g., point 24A, tends to run in the direction indicated by the arrow of FIG. 4 toward the lowest elevation of the bonnet 16 and drip from the lowest point, e.g. point 24B. This phenomenon makes the distribution of water across the corrugated paper pad 8 uneven, lowers the efficiency of the evaporative air conditioning system 6, and when a particular portion of the corrugated paper pad 8 becomes excessively wet, it tends to cause further water waste.

Thus, what is needed in the art is a water distribution mechanism that does not allow the water to spray unimpeded toward the corrugated paper pad, that compensates for differences in elevation of the bonnet covering spray pipe, that minimizes water waste, and that is easy to assemble.

### SUMMARY OF THE INVENTION

The problems noted above are solved in large part by a novel spray bar and bonnet arrangement. In particular, the bonnet and spray bar are configured such that for water to exit the water distribution mechanism at all, it preferably has to drip. That is, there is preferably relatively few, if any, exit paths from the water distribution mechanism that form a straight line between top dead center of the bonnet and the corrugated paper pad below. In this way, water must strike at least two surfaces of the water distribution mechanism before falling onto the corrugated paper pad, and thus is not allowed to splatter out of the spray pipe and bonnet mechanism with much, if any, horizontal velocity.

In a second aspect of the invention, the preferred embodiment of the bonnet itself has formed therein a plurality of teeth at the edge from which water drips, the drip surface, onto the corrugated paper pad. Having these teeth at the bottom portion of the bonnet therefore does not allow water to run along the lower edge when there are differences in elevation of the bottom of the bonnet. Thus, even in spite of sags or droops in the overall water distribution system, water droplets preferably drip off the first tooth they encounter on the drip portion of the bonnet.

In a final aspect of the invention, the preferred embodiment comprises a structure that houses the water distribution mechanism, and a corresponding structure, near the bottom of the corrugated paper pad, that acts to support the pad, as well as a trough in which water that migrates completely through the pad is collected before moving by force of gravity to a sump. Construction of the lower trough advantageously includes flanges on each end of the trough such that standard length of trough may be connected together to create the overall evaporative air conditioning assembly, and to reduce water waste.

### DESCRIPTION OF THE DRAWINGS

For a detailed description of the preferred embodiments of the invention, reference will now be made to the accompanying drawings in which:

FIG. 1 shows a perspective view of a poultry house having an evaporative air conditioning system;

FIG. 2 shows a more detailed perspective view of an evaporative air system;

FIG. 3 shows a cross-sectional view taken substantially along 3-3 of FIG. 2 of the water distribution mechanism of the prior art;

FIG. 4 shows a side view of a bonnet of the prior art taken substantially along line 4-4 of FIG. 3;

FIG. 5 shows a cross-sectional view of a water distribution mechanism of the preferred embodiment;

FIG. 6 shows a side view of the bonnet of the preferred embodiment substantially along line 6-6 of FIG. 5;

FIG. 7 shows the water distribution mechanism of the preferred embodiment within a stainless steel supporting structure of the preferred embodiment;

FIG. 8 shows a housing and trough section of the preferred embodiment; and

FIG. 9 shows a partial cut-away view of a spray bar within the bonnet.

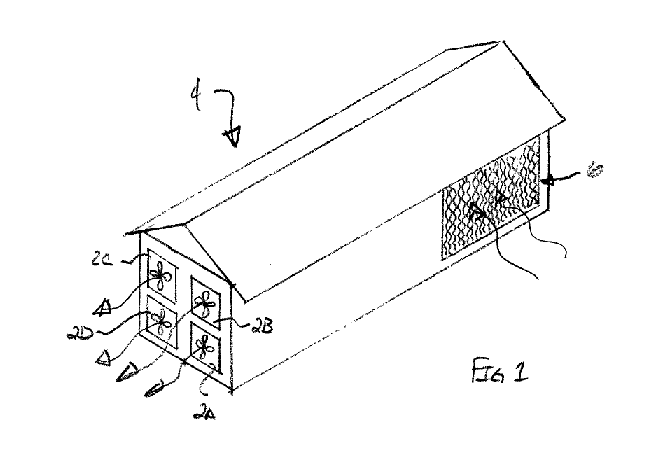

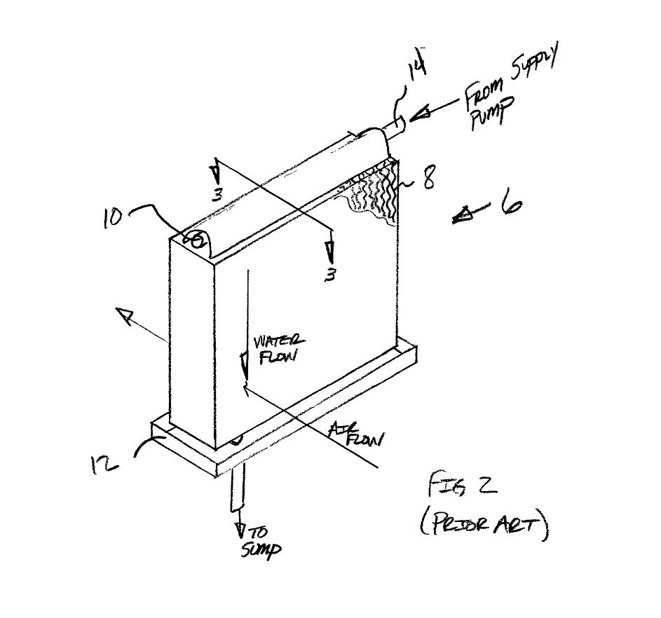

### NOTATION AND NOMENCLATURE

Certain terms are used throughout the following description and claims to refer to particular system components. In the following discussion and in the claims, the terms “including” and “comprising” are used in an open-ended fashion, and thus should be interpreted to mean “including, but not limited to . . . ”. Further, terminology regarding poultry houses may be different from company to company and indeed from state to state. The description herein is not meant to distinguish between regional or company-specific terms which refer to the same devices or structures. For example, a poultry house may likewise be called merely a house or barn. Likewise, an evaporative air conditioning system may likewise be called an air conditioning system, an air washer, and the like. Although the following description uses the term “poultry house” and “evaporative air conditioning system,” the description and the claims should be construed to cover all such variations referring to the same structures.

### DETAILED DESCRIPTION OF THE PREFERRED EMBODIMENTS

The preferred embodiment of the present invention has three aspects; a water distribution mechanism 50 that minimizes or alleviates splattering of the water from the bonnet 52 onto the corrugated paper pad 58; a plurality of teeth 56 along the drip edge (the bottom portion) of the bonnet 52; and an advantageous structure for housing the waste distribution mechanism and pad. Each of these will be addressed in turn.

Referring now to FIG. 5, there is shown a cross-sectional view of a water distribution mechanism 50 of the preferred embodiment. In particular, the water distribution mechanism 50 comprises a cover or bonnet 52 having within its interior a spray pipe or spray bar 56. The sectional view of FIG. 5 shows that the bonnet defines a partially enclosed region. The cross-sectional view of the prior art bonnet 16, made by splitting a pipe in half, spans an arc of 180 degrees, and does not extend below a lower surface of the spray bar 18. The preferred spray bar 56 (FIG. 5) clearly spans an arc of greater than 180°, and preferably spans approximately 270°. Preferably, the bonnet 52 is 3″ Schedule 40 PVC pipe having an arcuate portion cut therefrom to form the opening 60. Although PVC is the preferred material because of its availability, workability, and cost, any material may be used to create the bonnet 52 including steel, aluminum, wood, and the like.

Housed within the bonnet 52 is the spray bar 56. Preferably, this spray bar has on its upward facing surface a plurality of holes 62 through which water, at high pressure within the spray pipe 56, is allowed to exit in an upward direction. The spray bar 56 is preferably 1″ Schedule 40 PVC. However, any suitable material may be used, including aluminum, steel, stainless steel and the like. The periodically spaced holes 62 are preferably in 7/64″ diameter and spaced 1½″ apart.

The spray bar 56 is preferably suspended within the bonnet 52 by means of a plurality hollow mounting brackets. In the preferred embodiment, those brackets are preferably of 2″ stainless steel rings having a ⅜″ width. Although the ring 64 is preferably stainless steel, any suitable material may be used. Further, 2″ diameters need not necessarily be used, so long as other parameters (discussed below) are satisfied. Thus, the plurality of these stainless steel rings 64 are preferably connected by any suitable fastener in a spaced fashion on the inside of the bonnet 52 as shown in FIG. 5 (only one such ring 64 shown in FIG. 5). The spray bar 56 preferably slides in the stainless steel ring 64 in a longitudinal fashion, and then rests by force of gravity on a lower portion of the stainless steel rings.

In operation, water is forced into the spray bar 56 inside diameter under pressure. Because of the holes 62 in the upward facing surface of the spray bar 56, that water exits having a particular velocity, depending, in part upon the pressure of the water, toward an upper surface of the inside diameter of the spray bonnet 52. In particular, the water preferably strikes an inside upper portion of the bonnet: in the preferred semi-circular bonnet, the upper-most portion of the curvature.

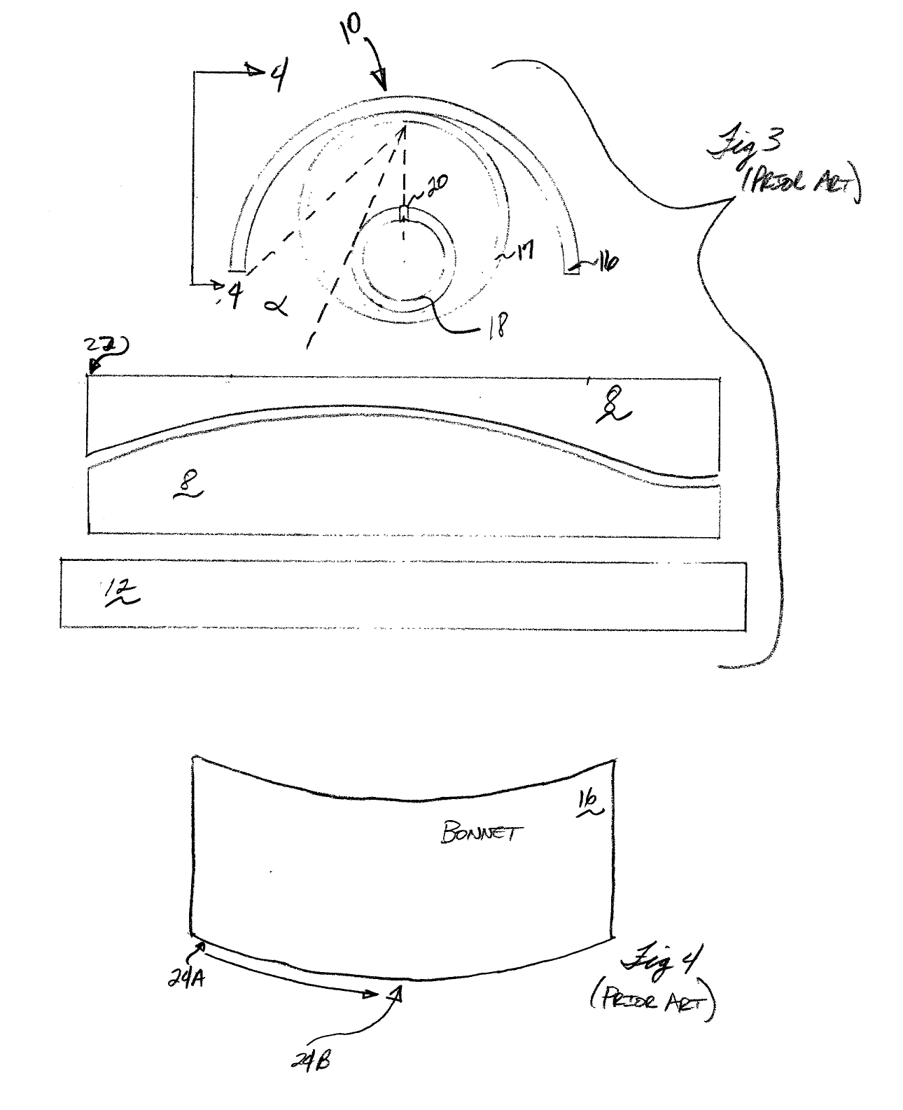

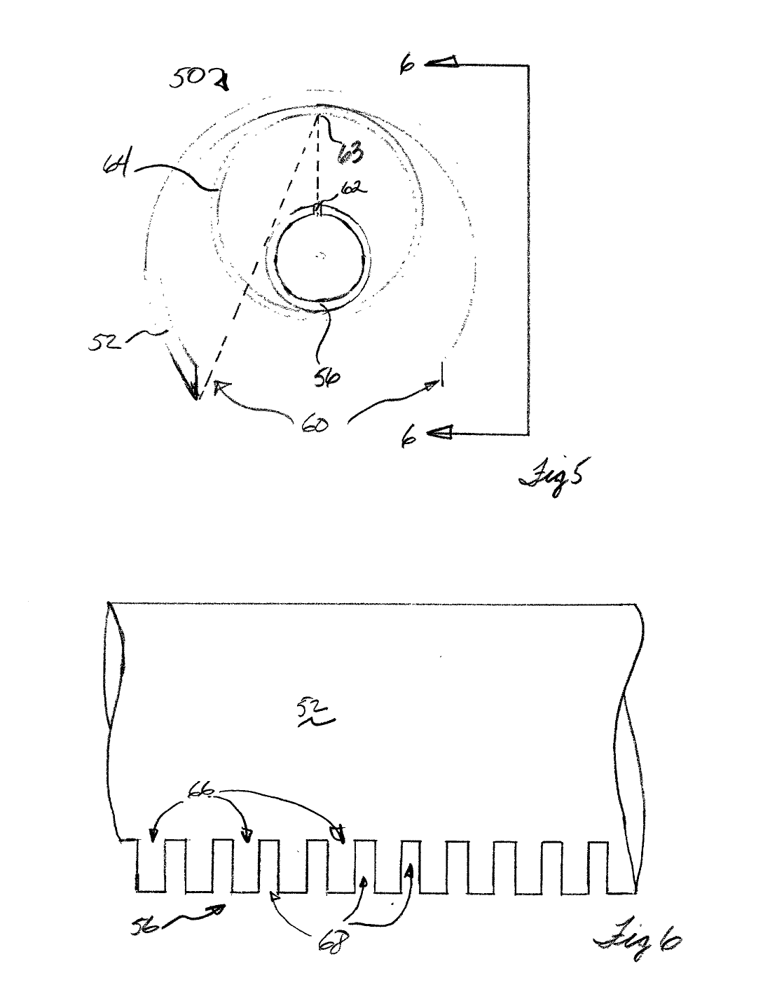

In the prior art, the water exiting and splashing or splattering off the inside of the bonnet could then move or fall out of the water distribution mechanism without contacting any further surfaces. That is, and referring again to the prior art drawing of FIG. 3, water could splash off the upper inside diameter of the bonnet and have a direct path for movement out of the spray mechanism as indicated by the pie-shaped area α. If the water distribution mechanism was situated high enough above the paper pad, or the air flow between the pad and the water distribution mechanism was strong enough, that water either sprayed beyond the pad to the ground, or was carried in droplet form by the moving air. The preferred embodiment of the present invention addresses that shortcoming of the prior art by adjusting the relative positions and sizes of the structures of the water distribution system 50 to alleviate that problem. In particular, and referring again to FIG. 5, the preferred embodiment has an arrangement of the bonnet 52 and spray bar 56 such that water preferably contacts at least two interior surfaces before being allowed to drop or otherwise fall onto the corrugated paper pad. Stated differently, substantially all the water drips from the water distribution mechanism, be it from the drip surface of the bonnet or the spray bar, rather than splashing or spattering. In the preferred embodiment shown in FIG. 5, this physical arrangement is accomplished by extending the sides of the bonnet 52 (the downwardly extending side walls) until substantially no direct line exists from top dead center 63 of the inside diameter of the bonnet to the exterior of the bonnet. The drawing of FIG. 5 shows an arrangement of the bonnet 52 and spray bar 56 which satisfies this parameter. As indicated, in the preferred embodiment, the bonnet 52 is extended to alleviate this splashing problem. Stated otherwise, the downwardly extending side walls of the bonnet 52 are arranged such that the opening 60 is only slightly larger than the diameter of the spray bar. However, one of ordinary skill in the art, now understanding how to alleviate water loss associated with this phenomenon, could easily develop many arrangements to accomplish this. For example, the spray bar 56 could be moved closer to the top dead center 63 of the bonnet 52. However, because the preferred embodiment also envisions removal of the spray bar 56 on a periodic basis for cleaning, this alternative regarding embodiment regarding placement of the spray pipe 56 closer to the spray bonnet 52 creates problems in facilitating that removal, cleaning, and reinstallation. Further, the goals could be achieved by other baffle mechanisms within the spray bonnet 56 to block these splashing paths. These embodiments are significantly more complicated to build and maintain than the embodiment shown in FIG. 5, and thus are not preferred.

As alluded to in the paragraph immediately above, the preferred embodiments envision a spray bar 56 that may be removed from the overall water distribution mechanism 50 for cleaning purposes. Referring now to FIG. 9, there is shown a partial cut-away view of the spray bar 56 within the bonnet 52. Preferably, the spray bar 56 rests on a lower portion of each of the stainless steel rings 64. Because in the preferred embodiment the spray bar 56 is a 1″ PVC pipe, and the stainless steel rings 64 are each preferably 2″, there is sufficient room within the stainless steel rings for removal of the spray bar 56. In particular, to remove the spray bar 56 requires closing the water supply at the valve 57, and disconnecting the universal connector 59. Once disconnected, the spray bar 56 may be removed from the water distribution mechanism 50 by sliding the bar in a horizontal fashion in the direction indicated by the arrow in FIG. 9. Once removed, any debris accumulated in the spray pipe or blocking the holes 62 (not shown in FIG. 9) may be cleaned and removed, and the spray bar 56 reinstalled by reversing the previously mentioned steps.

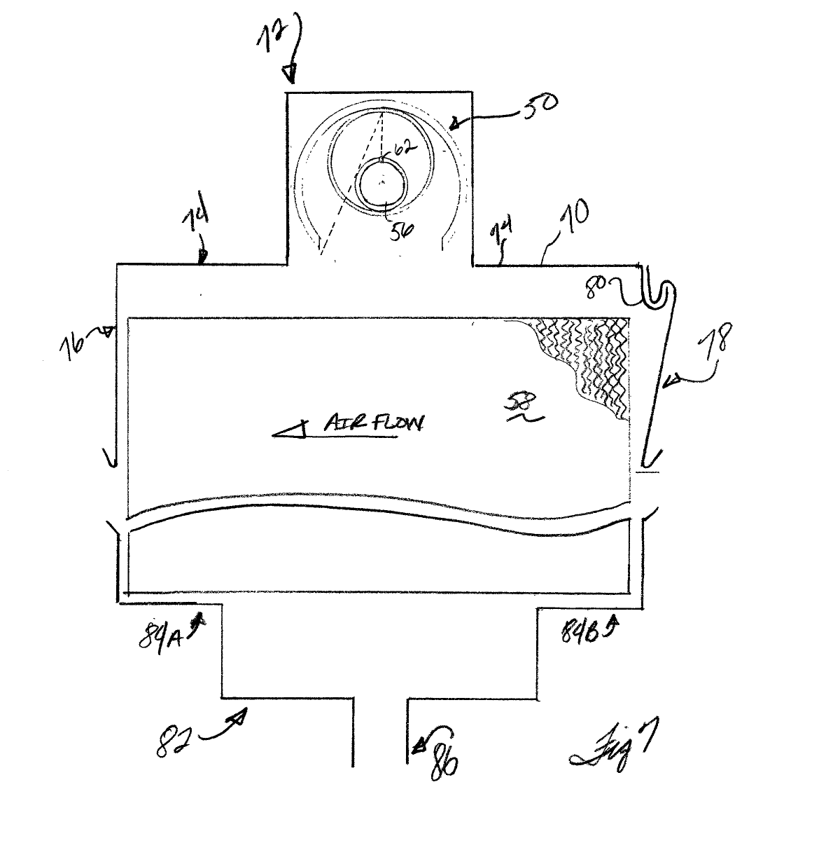

The second aspect of the invention compensates for irregularities in elevation at the drip portion of the bonnet 52. Referring to FIG. 6, there is shown a structure of a bonnet 52 taken substantially along line 6-6 of FIG. 5. Of particular importance are the downwardly extending protrusions, in the preferred embodiment a plurality of teeth 66 and notches 68 distributed about the lower or drip edge or drip surface of the bonnet 52. As previously mentioned, the bonnet 52 is preferably made of 3″ Schedule 40 PVC pipe. The teeth are preferably each ¼″ wide and created by removing or notching the PVC along its lower edge, with the notch preferably being 3/16″ wide. Although FIG. 6 only shows one side of the bonnet 52 having the teeth 66 and notches 68, it will be understood that preferably each side of the bonnet 52 has these structures.

The teeth 66 and corresponding notches 68 address the problems of the water running horizontally along the drip edge of the bonnet 52 to its lowest elevation. With these teeth 66 and notches 68 present, water tends to run along the inside diameter of the bonnet 52 and down onto one of these teeth 66. Even if the bonnet 52 of the preferred embodiment sags between connection points, the water drips from its corresponding tooth and does not run horizontally along the drip surface. In this way, the water is more evenly distributed along the corrugated paper pad 58 (not shown in FIG. 6), in spite of irregularities and imperfections in the installation of the water distribution mechanism 50. Having the rectangular teeth is the preferred embodiment; however, the teeth need not necessarily be rectangular. For example, triangular or semi-circular teeth or protrusions from the drip edge of the bonnet 52 may be operational, but because of the difficulty in creating those patterns along the drip edge of the bonnet 52, they are not preferred.

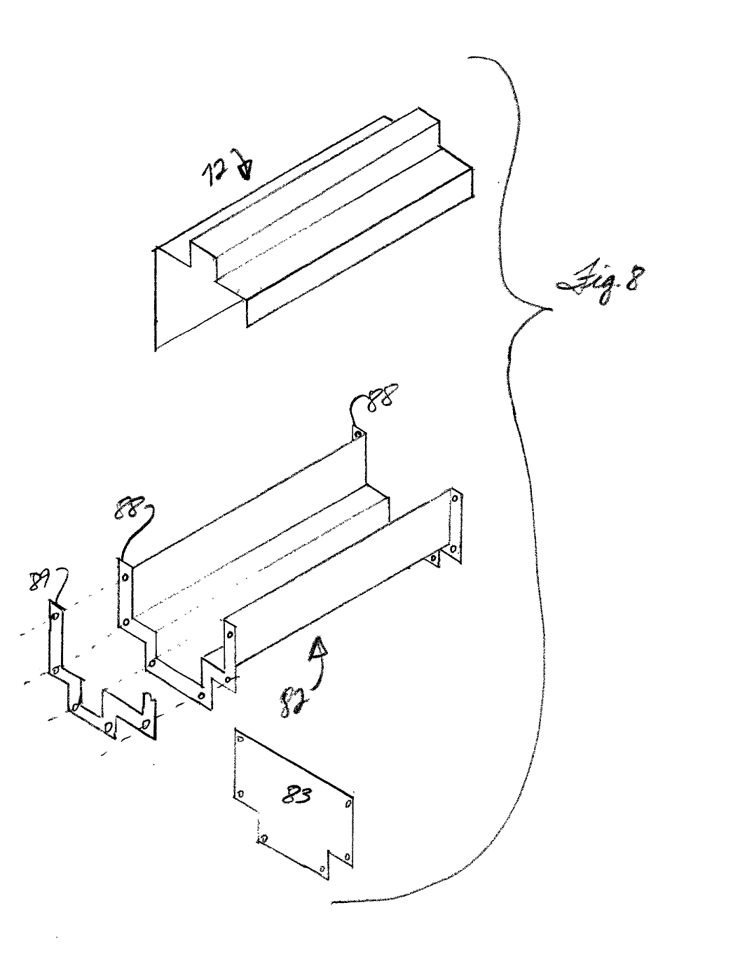

Referring now to FIG. 7, there is shown the water distribution mechanism 50 within a housing 70. As indicated in FIG. 7, the housing 70 has an upper rectangular portion 72 adapted to hold the water distribution mechanism 50. The housing 70 also has two horizontal members 74 which extend substantially horizontally from upper rectangular portion 72. On the downstream side of the air flow, the housing 70 also comprises a backing member 76. In operation, air flow through the corrugated paper pad 58 tends to push that pad against the backing member 76. On the upstream side of the air flow is a removable member 78. This removable plate member 78 is preferably constructed so as to hang on a lip 80 of the structure 70. The removable member may be removed to allow removal of the corrugated paper pad 58. Each of the housing 70 and removable member 78 are preferably made of 304 stainless steel; however, other materials may be used, e.g. other stainless compositions, or merely galvanized metals.

In operation, water from a sump (not shown) is pumped by a pump (not shown) into the spray pipe 56. Because of the holes 62 in the upper portion of the spray bar 56, which holes are preferably 1½″ apart and having a diameter of 7/64″, the water sprays out of the top surface or portion of the spray bar 56 and strikes an upper portion of the bonnet 52. Some of that water may immediately drip back down onto the spray bar 56 and then onto the corrugated paper pad 58. Some of that water may likewise splatter or splash toward the inside diameter of the bonnet 52, which water is then dripped from the lower drip edges of the bonnet 52 onto the corrugated air filter 58. Finally, some of that water may not splash at all and instead merely runs around the inside diameter to drip as previously described. Once the water drips onto the corrugated air filter 58, the force of gravity tends to pull water through the filter. At the same time, air flow preferably moves through the filter at substantially right angles to the direction of water flow through. The air looses heat in the process of changing the water from liquid to a gaseous form. Water that is not evaporated and that runs through the corrugated paper pad 58 is collected in a portion of trough section 82, which is also preferably made of stainless steel. The trough 82 preferably comprises two shoulders 84A and 84B upon which a lower portion of the corrugated paper filter 58 rests. The water flow dripping off the lower portion of the corrugated air filter 58 accumulates in the basin portion of the trough and then runs, preferably by force of gravity, through the exit pipe 86 back to the sump (not shown), where the process starts again. Any water lost during the process is preferably added to the sump, for example, by means of a float connected to a valve maintaining a particular level in the sump.

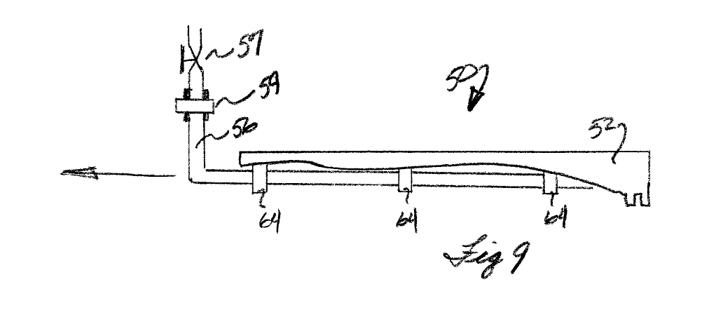

Referring now to FIG. 8, there is shown a perspective view of the housing 72 and the trough section 82. In particular, FIG. 8 shows that preferably each trough 82 has a flange 88 on each end. Constructing the lower portion of the evaporative air conditioning system 6 involves bolting a plurality of these troughs 82 together to form a trough assembly of the proper length. In the preferred embodiment, each of these troughs is 10′ long. Thus, to make an air washer having a length of 30′, three such troughs would be required. Preferably, a plurality of bolts holds each of the troughs together, and a gasket or O-ring 89 preferably seals the two mating portions. The gasket or O-ring 89 may be made of any suitable material, such as rubber. On the ends of the trough 82 that are not connected to a corresponding trough, a blind flange 83 is used to retain the water within the trough 82. Correspondingly, the upper housing 72 is likewise preferably 10′ in length, and a plurality of these are placed end-to-end to create the overall upper housing.

The above discussion is meant to be illustrative of the principles and various embodiments of the present invention. Numerous variations and modifications will become apparent to those skilled in the art once the above disclosure is fully appreciated. For example, the preferred embodiments show the bonnet having semi-circular cross-section; however, the bonnet need not be circular in any form, and could be square tubing, either mounted horizontally or rotated such that one of the 90° angles forms the upper portion of the bonnet. Further, the bonnet could be made of some angle material, for example, angle iron, having additional portions welded thereto to create a baffle as to the water flow to alleviate the splashing. Likewise, with respect to the trough sections, the devices need not be made of stainless steel, and could be formed of plastic materials, such as PVC. Further, the spray bar need not necessarily be a pipe having a circular cross-section, and instead could be any tubular material through which water may be pumped and holes drilled to create the water flow or water streams of the water distribution mechanism. It is intended that the following claims be interpreted to embrace all such variations and modifications.

What is claimed is:

1. A water distribution structure for an evaporative air conditioner, the water distribution structure comprising:
a bonnet having a length and a cross section at substantially right angles to the length, wherein the cross section forms a partially enclosed region;
a spray bar having a length mounted within the partially enclosed region of the bonnet with the lengths of the spray bar and bonnet substantially parallel, and wherein the spray bar has a plurality of periodically spaced holes through an upper surface through which pressurized water sprays;
said bonnet having an upper portion above the plurality of periodically spaced holes of the spray bar, and the upper portion of the bonnet directing the pressurized water generally downward; and
said bonnet also having at least two downwardly extending side walls, and wherein the side walls extend below a bottom portion of the spray bar.

2. The water distribution structure as defined in claim 1 wherein the spray bar further comprises a spray pipe having circular cross section.

3. The water distribution structure as defined in claim 2 wherein the spray pipe has a one inch diameter.

4. The water distribution structure as defined in claim 2 wherein the spray pipe is constructed of PVC.

5. The water distribution structure as defined in claim 1 wherein the bonnet further comprises a pipe of circular cross section with a lower portion removed.

6. The water distribution structure as defined in claim 5 wherein the bonnet is constructed of PVC.

7. The water distribution structure as defined in claim 5 wherein the cross section of the bonnet spans an arc greater than 180 degrees.

8. The water distribution system as defined in claim 7 wherein the cross section of the bonnet spans an arc of substantially 270 degrees.

9. The water distribution system as defined in claim 1 further comprising:
said spray bar has a substantially circular cross; and
said bonnet has a substantially semi-circular cross section forming the partially enclosed region, and wherein an upper portion of the semi-circular cross section forms the upper portion of the bonnet, and wherein downwardly extending portions of the semi-circular cross section form the at least two downwardly extending side walls.

10. A method of distributing water along a pad of an evaporative air conditioner, the method comprising:
spraying water substantially upward from a spray bar;
redirecting the water substantially downward with a bonnet covering the spray bar;
allowing the water to exit the bonnet with substantially no horizontal velocity; and thereby
applying the water to the pad.

11. The method of distributing water along a pad of an evaporative air conditioner as defined in claim 10 wherein spraying the water substantially upward from the spray bar further comprises:
pumping water into a pipe of substantially circular cross-section and having a plurality of periodically spaced holes in an upper portion thereof; and thereby
forming a plurality of water streams traveling substantially upward.

12. The method of distributing water along a pad of an evaporative air conditioner as defined in claim 10 wherein redirecting the water substantially downward further comprises:
placing the bonnet, having a semi-circular cross-section, over the spay bar;
splashing the water against an upper inside surface of the bonnet; and thereby
forcing the water to move downwardly.

13. The method of distributing water along a pad of an evaporative air conditioner as defined in claim 10 wherein allowing the water to exit the bonnet with substantially no horizontal velocity further comprises:
extending side portions of the bonnet below a lowest portion of the spray bar; and
configuring a water exit portion of the bonnet to be only slightly larger than a diameter of the spray bar.

14. The method of distributing water along a pad of an evaporative air conditioner as defined in claim 10 wherein applying the water to the pad further comprises dripping at least some of the water from a drip edge of the bonnet.

15. A water distribution system that distributes water across a pad of an evaporative air conditioning system, the water distribution system comprising:
a bonnet having a length, and also having a cross section that defines a partially enclosed region, an open portion of the partially enclosed region opening substantially downward;
a spray bar mounted within the partially enclosed region, and wherein the spray bar directs a plurality of water streams toward an inside surface of the bonnet;
said bonnet also having a drip surface extending the length of the bonnet along a lower portion of the bonnet adjacent to the open portion of the partially enclosed region; and
a plurality of protrusion along the drip surface, the protrusions configured to inhibit horizontal movement of water along the drip surface.

16. The water distribution system as defined in claim 15 wherein said protrusions are teeth formed by cutting a plurality of notches along the drip surface, said notches cut substantially perpendicular to the length of the bonnet.

17. The water distribution system as defined in claim 15 wherein the bonnet further comprises a semi-circular cross section.

18. The water distribution system as defined in claim 17 wherein said protrusions are teeth formed by cutting a plurality of notches along the drip surface, said notches cut substantially perpendicular to the length of the bonnet.

19. A method of distributing water across an upper surface of a pad of an evaporative air conditioner, the method comprising:
applying water to an inside surface of a bonnet extending substantially across the upper surface of the pad;
allowing the water to migrate along the inside surface of bonnet to a drip edge; and
dripping the water from a plurality of protrusions onto the pad, wherein the plurality of protrusions extend downwardly from the drip edge.

20. The method of distributing water across an upper surface of a pad of an evaporative air conditioner as defined in claim 19 wherein applying water to an inside surface of the bonnet further comprises;
placing a pipe having a plurality of holes in an upper surface thereof beneath the bonnet;
orienting the plurality of holes of the pipe substantially upward;
pumping water into the pipe; and thereby
creating a plurality of water streams from the pipe that strike the inner surface of the bonnet.

21. A water distribution structure for an evaporative air conditioner, the structure comprising:
a cover having an inside surface, the inside surface configured to redirect a flow of water from a substantially upward direction to a substantially downward direction;
a plurality of hollow mounting brackets mounted on the inside surface of the cover;
a spray bar telescoped through the plurality of hollow mounting brackets, and thus mounted in the cover;
a coupling on an end of the spray bar, wherein disconnecting the coupling disconnects the spray bar from a water source; and
wherein the spray bar is removable from the cover by disconnecting the coupling and pulling the spray bar out of the plurality of hollow rings.

22. The water distribution structure as defined in claim 21 wherein the cover having an inside surface further comprises a pipe of circular cross-section with a lower portion of the pipe removed such that the remaining portions of the pipe cross-section spans an arc of greater than 180 degrees.

23. The water distribution structure as defined in claim 22 wherein the pipe cross-section spans an arc of substantially 270 degrees.

24. The water distribution structure as defined in claim 21 wherein the spray bar further comprises a pipe constructed of PVC having a periodically spaced holes drilled through an upper portion of the pipe.

25. The water distribution structure as defined in claim 21 wherein the hollow mounting brackets further comprise metallic rings.

26. The water distribution structure as defined in claim 25 wherein the metallic rings further comprise stainless steel rings of substantially circular cross-section.

27. An evaporative air condition structure comprising:
a trough assembly adapted to support a pad and provide a mechanism to direct water flow from the pad to a reservoir;
said pad standing in the trough and extending substantially upward;
an upper housing configured to hold an upper portion of the pad, and further configured to house a water distribution system;
wherein the trough assembly further comprises:
a plurality of trough sections, each trough section having a flange on each end adapted to connected trough sections to each other;
a gasket associated with each trough section flange;
at least two trough sections coupled at their respective flanges; and
at least two blind flanges coupled on each end of the trough assembly thereby defining ends of the trough assembly.

28. The evaporative air condition structure as defined in claim 27 wherein the trough sections further comprise:
basin having two basin walls and basin floor, wherein the walls of the basin are substantially perpendicular to the floor and extend upward;
a shoulder section connected to each basin wall, each shoulder section extending away from the basin and being substantially parallel to the basin floor;
a pad retaining section connected to each shoulder section, each pad retaining section extending substantially upward from its respective shoulder section; and
said flanges connected to each end of the trough section, wherein the flanges are adapted to connect in mating relationship with flanges from other trough sections.

29. The evaporative air condition structure as defined in claim 28 wherein the trough sections are made of stainless steel.

30. The evaporative air condition structure as defined in claim 28 wherein the gasket associated with each trough section flange is made of rubber.

31. A method of operation a water distribution system for an evaporative air conditioning system, the method comprising:
distributing water across a pad of the evaporative air conditioning system with a spray bar and bonnet assembly; and when said spray bar needs cleaning
closing a supply valve to the spray bar;
disconnecting a coupling on a downstream side of the supply valve;
removing the spray bar from within the bonnet assembly by telescoping the spray bar from the bonnet assembly until the spray bar has been removed.

32. The method of operation a water distribution system as defined in claim 30 further comprising:
installing the spray bar in the bonnet by telescoping the spray bar into the bonnet assembly;
connecting the universal coupling; and
opening the supply valve to the spray bar.

33. A water distribution structure for an evaporative air conditioner, the water distribution structure comprising:
a bonnet having a length and a cross section at substantially right angles to the length, wherein the cross section forms a partially enclosed region;
a spray bar mounted within the partially enclosed region of the bonnet, wherein the spray bar has a plurality of periodically spaced holes through an upper surface through which pressurized water sprays;
said bonnet also having an upper portion above the plurality of periodically spaced holes of the spray bar, and the upper portion of the bonnet directing the pressurized water generally downward;
said bonnet also having at least two downwardly extending side walls, and wherein the side walls extend below a bottom portion of the spray bar; and
a drip surface extending the length of the bonnet along a bottom portion of the downwardly extending side walls, the drip surface having a plurality of protrusions configured to inhibit horizontal movement of water along the drip surface.

34. The water distribution structure for an evaporative air conditioner as defined in claim 33 further comprising:
said spray bar being a pipe having substantially circular cross-section;
said cross-section of the bonnet being substantially semi-circular and forming the partially enclosed region, and wherein an upper portion of the semi-circular cross section forms the upper portion of the bonnet, and wherein the downwardly extending portions of the semi-circular cross section form the at least two downwardly extending side walls; and
wherein said protrusions are teeth formed by cutting a plurality of notches along the drip surface, said notches cut substantially perpendicular to the length of the bonnet.

35. The water distribution structure for an evaporative air conditioner as defined in claim 34 wherein each of the spray bar and bonnet are made of PVC.

36. The water distribution structure for an evaporative air conditioner as defined in claim 34 wherein the semi-circular cross section of the bonnet spans an are of greater than 180 degrees.

37. The water distribution structure for an evaporative air conditioner as defined in claim 36 wherein the semi-circular cross section of the bonnet spans an are of substantially 270 degrees.
